(19) United States
(12) Patent Application Publication
(10) Pub. No.: US 2021/0292208 A1
(43) Pub. Date: Sep. 23, 2021

(54) SYSTEM AND METHOD FOR REDUCING VOLUME OF SEWAGE SLUDGE

(71) Applicant: Tapas CHATTERJEE, New Delhi (IN)

(72) Inventor: Tapas CHATTERJEE, New Delhi (IN)

(21) Appl. No.: 17/262,196

(22) PCT Filed: Mar. 27, 2019
(86) PCT No.: PCT/IB2019/052477

§ 371 Date: Jan. 21, 2021

(30) Foreign Application Priority Data
Jul. 27, 2018 (IN) 201811028270

(51) Int. Cl. C02F 11/13; F23G 7/00

(52) U.S. Cl. CPC C02F 11/13; F23G 7/001; F23G 5/30; F23G 2201/10; F23G 2209/12

(57) ABSTRACT

The present invention relates to system and method for reducing the volume of sewage sludge, the system comprises a dryer adapted to receive the sewage sludge and a drying gas and produce a mixture comprising a dried sludge component and a gaseous component therefrom. The system further comprises a solid-gas separator for separating the dried sludge component from the gaseous component. The system further comprises a hot air generator connected to said solid-gas separator and the dryer, and adapted to receive a feed gas and at least a portion of said dried sludge component from the solid-gas separator to combust the dried sludge component to produce a heat of combustion and convert, using the heat of combustion, the feed gas to drying gas for supply to the dryer.

### FIELD OF THE INVENTION

The present invention relates to system and method for reducing the volume of sewage sludge. In particular, the invention relates to a self-sustained system and a self-sustained method for reducing the volume of municipal sewage sludge.

### BACKGROUND OF THE INVENTION

Municipal sludge generated from the city drainage water has become a problematic task because of the volume of the sludge produced which needs to be disposed of and non-availability of dumping area. In fact, the sludge comes out with 78% moisture after centrifugation and average volume varies from 10,000 M³/day to 150,000 M³/day depending on the size of the plant. A variety of ways to reduce the volume of the sludge has been disclosed in the prior art, which is being described hereinbelow.

For example, U.S. Pat. No. 3,954,069 discloses a process comprising the steps of mechanically de-watering aqueous sewage sludge to obtain a wet sludge having a high solids content; indirectly heating and substantially completely drying said wet sludge in a heated dryer, thereby producing in the dryer a dried sludge and a water vapor-containing exhaust gas; conducting said dried sludge from the dryer to a solid refuse incinerator for incineration; conducting said water vapor-containing exhaust gas from the dryer through a condenser, whereby the water vapor is condensed and removed from the exhaust gas to produce a substantially dry exhaust gas; and conducting said substantially dry exhaust gas from the condenser into the combustion chamber of said incinerator, whereby said exhaust gas is deodorized by heating with the aid of the hot combustion gases in the incinerator.

By way of another example, U.S. Pat. No. 4,311,103 discloses an incineration system for sewage sludge dehydrated to about 70% of water content comprising: a hopper for receiving said sludge; a drying furnace connected to said hopper by a supplying means for supplying said sludge from said hopper to said furnace, said furnace having a fluidized sand bed, whereby said sludge is dried to a solid component and a gaseous component; a circular circuit for said gaseous component comprising said drying furnace, a first feed pipe connected to said furnace, a heat exchanger connected to said first feed pipe, and a second feed pipe connecting said heat exchanger and said furnace, including means for conveying said solid component along part of said circuit; a first incinerator connected to said circuit for receiving a portion of said gaseous component and said solid component, for incompletely combusting said components; means for supplying to said first incinerator preheated air in insufficient quantity to completely combust said components; a second incinerator connected to said first incinerator for receiving the products of said incomplete combustion and connected to said circuit for receiving another portion of said gaseous component, for completely combusting said gaseous portion and said products of incomplete combustion; and a means for supplying to said second incinerator sufficient preheated air to completely combust said gaseous portion and said products of incomplete combustion, wherein said second incinerator has a discharge means connected to said heat exchanger for discharging the products of said complete combustion to said heat exchanger in which their temperature is reduced.

By way of another example, U.S. Pat. No. 5,230,211 discloses a process for the partial oxidation of sewage sludge and the production of clean synthesis gas, fuel gas, and electrical power, comprising:

(1) splitting a stream of dewatered sewage sludge having a solids content in the range of about 17 to 40 wt. % into a first stream comprising about 35° to 75 wt. % of the dewatered sewage sludge stream and a second stream comprising the remaining 65 to 25 wt. % of the dewatered sewage sludge stream;

(2) drying the first stream of dewatered sewage sludge to produce a stream of dried sewage sludge having a solids content in the range of about 75 to 99 wt. %;

(3) grinding the dried sewage sludge from (2) to a particle size so that 100 wt % passes through ASTM E11 Standard Sieve Designation 1.40 mm;

(4) mixing about 2.0 to 8.0 parts by dry weight aqueous slurry of solid carbonaceous fuel having a solids content of about 50 to 70 wt. % with each part by weight of said second stream of dewatered sewage sludge from (1) to produce a slurry comprising sewage sludge and solid carbonaceous fuel having a solids content in the range of about 40 to 60 wt. %;

(5) heating the solid carbonaceous fuel-sewage slurry from (4) to a temperature in the range of about 140° F. to 212° F.; and mixing together 3 to 9 parts by dry weight of the solid carbonaceous fuel-sewage sludge slurry from (4) with each part by weight of dried sewage sludge from (2) to produce a pumpable fuel slurry comprising sewage sludge and solid carbonaceous fuel and having a solids content in the range of about 45 to 70 wt. %;

(6) reacting said pumpable fuel slurry from (5) in the reaction zone of a partial oxidation gas generator at a temperature in the range of about 1800° F. to 3500° F. and a pressure in the range of about 1-35 atmospheres, and in the presence of free-oxygen containing gas, thereby producing a hot raw effluent gas stream of synthesis gas, reducing gas or fuel gas;

(7) cooling, cleaning and purifying said raw effluent gas stream to produce a stream of fuel gas;

(8) burning the fuel gas from (7) with air in a combustor of a gas turbine, and passing the hot exhaust gas through an expansion turbine which drives an electric generator; and

(9) passing the hot exhaust gas from (8) in indirect heat exchange with water to produce steam for use in drying said the first stream of dewatered sewage sludge in (2) and/or for heating said solid carbonaceous fuel-sewage slurry is (5) by indirect heat exchange.

By way of another example, an article entitled “INCINERATING SEWAGE SLUDGE AND PRODUCING REUSABLE ASH: JAPANESE EXPERIENCE” by TAKESHIOKU FUJI, Takuma Co. Ltd., Osaka, Japan which can be downloaded from “http://www.seas.columbia.edu/earth/wtert_/sofos/nawtec/1990-National-Waste Processing-Conference/1990-National-Waste-Processing-Conference-05.pdf” discloses a system for incinerating sewage sludge.

By way of another example, Lonza Engineering Ltd. provides a self-sustaining system for incineration of municipal sewage sludge based on “RASCHHA” fluidized bed incineration technology, details of which can be obtained from https://www.lonza.com/˜/media/Files/engineering/Raschka%20Sludge%20Incineration.ashx.

By way of another example, an article entitled “Incineration Plants for Municipal and Industrial Sludge” as available at http://www.outotec.com/globalassets/products/energy-production/outotec_incineration_plants_for_municipal_and_industrial_sludge_eng_web.pdf discloses an incineration plant for volume reduction of municipal sludge.

Thus, it can be observed that several attempts have been made to reduce the volume of sewage sludge. However, the systems are riddled with one or more disadvantages which are known to persons skilled in the art. For example, the systems that have been developed are complicated in terms of their construction and in terms of their operation. In many instances, a substantial amount of pre-processing of the sludge is required. In some instances, the systems produce by-products that need substantial treatment before being disposed of.

In light of the above, there exists a need to provide a system and a method for reducing the volume of municipal sewage sludge.

### SUMMARY OF THE INVENTION

This summary is provided to introduce a selection of concepts in a simplified format that is further described in the detailed description of the invention. This summary is neither intended to identify key or essential inventive concepts of the invention and nor is it intended for determining the scope of the invention.

According to an aspect of the invention, there is provided a system for reducing a volume of input sewage sludge. In an embodiment of the invention, the system for reducing the volume of sewage sludge comprises a dryer adapted to receive the sewage sludge and a drying gas and produce a mixture comprising a dried sludge component and a gaseous component therefrom. The system further comprises a solid-gas separator for separating the dried sludge component from the gaseous component. The system further comprises a hot air generator connected to said solid-gas separator and the dryer. In an embodiment of the invention, the hot air generator is adapted to receive a feed gas and at least a portion of said dried sludge component from the solid-gas separator. The hot air generator is further adapted to combust the dried sludge component to produce a heat of combustion and convert, using the heat of combustion, the feed gas to drying gas for supply to the dryer.

According to another aspect of the invention, there is provided a method for reducing a volume of input sewage sludge. The method comprises feeding the sewage sludge and drying gas to a dryer thereby producing a mixture comprising a dried sludge component and a gaseous component. The method further comprises feeding the mixture comprising the dried sludge component and the gaseous component to a solid-gas separator thereby separating the dried sludge component from the gaseous component. The method further comprises feeding a feed gas, at least a portion of said dried sludge component and optionally a start-up fuel to a hot air generator. The method further comprises combusting the dried sludge component and optionally the start-up fuel in the hot air generator to produce a heat of combustion. The method further comprises converting, the feed gas to drying gas for supply to the dryer, using the heat of combustion.

In an embodiment of the invention, the system, as well as the method, is self-sustaining in that energy required for drying of the sludge is produced by combustion of the dried sludge component thus produced. Also, the system and the method allows for close to 90% reduction of the volume of the sewage sludge. In particular, the system and the method allow for greater than 85% reduction of the volume of the sewage sludge.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 demonstrates a block diagram of the system for reducing the volume of the sludge in accordance with an embodiment of the invention; and

FIG. 2 demonstrates a detailed view of the system for reducing the volume of the sludge in accordance with an embodiment of the invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

Embodiments of the present invention will be described below in detail with reference to the accompanying drawings.

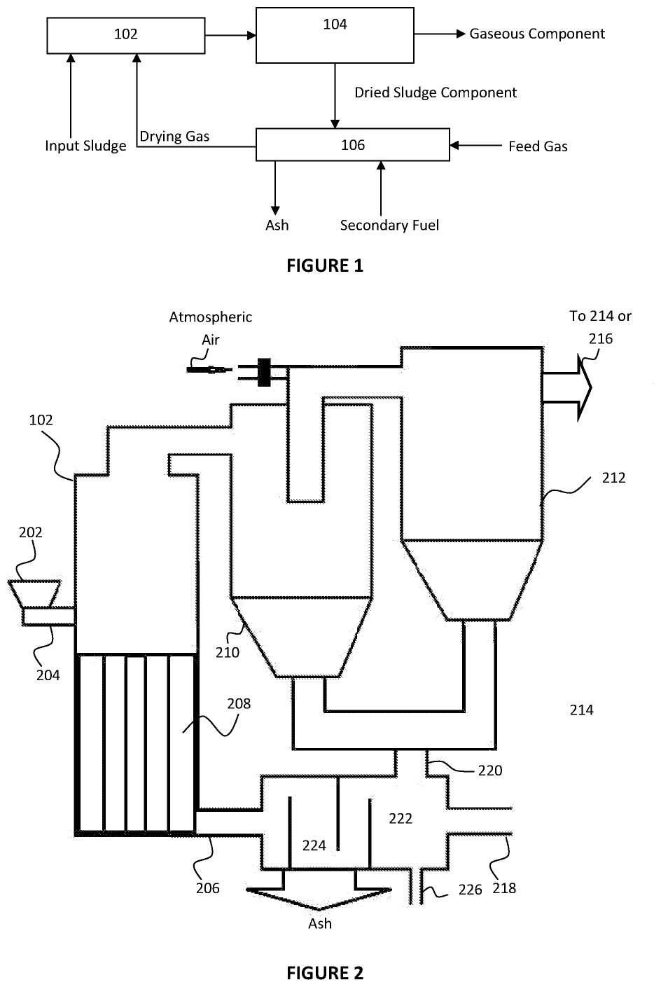

Referring to FIG. 1, there is illustrated a block diagram of a system (100) for reducing the volume of sewage sludge. The sewage sludge generally has a solids content in the range of about 18 to 20 wt. %. In a preferred aspect of the invention, the sewage sludge is a municipal sewage sludge.

The system (100) comprises a dryer (102) adapted to receive the sewage sludge. The dryer is further adapted to receive a drying gas. The dryer is adapted to produce a mixture comprising a dried sludge component and a gaseous component from the drying gas and the sewage sludge.

The system (100) further comprises a solid-gas separator (104) adapted to be operatively coupled to the dryer (102). The solid-gas separator (104) is adapted to separate the dried sludge component from the gaseous component.

The system (100) further comprises a hot air generator (106). The hot air generator (106) is operatively coupled to the solid-gas separator (104) and the dryer (102). The hot air generator (106) is adapted to receive a feed gas and at least a portion of the dried sludge component from the solid-gas separator (104). The hot air generator (106) is further adapted to combust the dried sludge component and generate a heat of combustion. The heat of combustion thus generated is used for producing drying gas (from the feed gas) for supply to the dryer (102).

Now referring to FIG. 2, which is a more detailed view of the system (100) for reducing the volume of the sewage sludge, it can be observed that the system further comprises a storage means (202) for receiving the sewage sludge. The storage means (202) may, for example, be a hopper (202). The system further comprises a conveyor means (204) for transporting the sewage sludge from the storage means (202) to the dryer (102).

In an embodiment of the invention, the dryer (102) may be a direct heating type dryer or an indirect heating type dryer. Preferably, the dryer (102) may be a direct heating type dryer. In particular, the direct heating type dryer may comprise a drying gas inlet port (206) located at about a bottom of the dryer, whereby said drying gas is supplied to the direct heating type dryer and allowed to flow upward and to mix with sewage sludge thereby producing the dried sludge component and the gaseous component. In a particular embodiment of the invention, the drying gas inlet port is located to introduce the drying gas in a tangential pattern within the dryer to establish a “cyclone” type air flow pattern within the dryer.

In an embodiment of the invention, the direct heating type dryer may comprise of a size reduction means (208) for reducing a size of the sewage sludge. In an embodiment of the invention, the size reduction means (208) may be adapted to apply shearing force on the sewage sludge, thereby reducing a size of the sewage sludge. In an embodiment of the invention, the size reduction means (208) may be adapted to apply cutting force on the sewage sludge, thereby reducing a size of the sewage sludge. In an embodiment of the invention, the size reducing means (208) may be adapted to apply a crushing force on the sewage sludge, thereby reducing a size of the sewage sludge.

By way of a non-limiting example, the size reduction means (208) may comprise one or more blades adapted to exhibit motion within the dryer. By way of another non-limiting example, the size reduction means (208) may comprise one or more impellers adapted to exhibit rotational motion within the dryer. It may be noted that while some examples of the size reduction means have been provided above, the scope of the invention in terms of the size reduction means (208) is not intended to be restricted to the examples provided above.

In an embodiment of the invention, the solid-gas separator (104) is selected from a group comprising a cyclone separator (210), a bag separator (212), a scrubber (214), an electrostatic precipitator (216), and combinations thereof. By way of a non-limiting example, the solid-gas separator may be a cyclone separator (210). By way of another non-limiting example, the solid-gas separator may be a combination of cyclone separator (210) and a bag separator (212). By way of another non-limiting example, the solid-gas separator may be a combination of cyclone separator (210) and a scrubber (214). It may be noted that while some examples of the solid-gas separator (104) have been provided above, the scope of the invention in terms of the solid-gas separator (104) is not intended to be restricted to the examples provided above.

In an embodiment of the invention, the hot air generator (106) comprises a feed gas inlet port (218) for introducing the feed gas; a first fuel inlet port (220) for introducing the dried sludge component received from the solid-gas separator (104); and a combustion zone (222) in operational interconnectivity with the feed gas inlet port (218) and the first fuel inlet port (220) for receiving there-from the feed gas and the dried sludge component, respectively, the combustion zone (222) being adapted to combust the dried sludge component to produce a heat of combustion and convert, using the heat of combustion, the feed gas to drying gas for supply to the dryer (102).

In an embodiment of the invention, the hot air generator (106) comprises at least one ash-separation zone (224) located downstream of the combustion zone (222) for promoting separation of ash from the drying gas, the ash being produced by combustion of the dried sludge component in the combustion zone (222).

In an embodiment of the invention, the hot air generator (106) comprises a second fuel inlet port (226) for introducing a start-up fuel to the combustion zone.

The present invention furthermore provides a method for reducing the volume of sewage sludge. The method comprises feeding the sewage sludge and drying gas to a dryer, thereby producing a mixture comprising a dried sludge component and a gaseous component. The method further comprises feeding the mixture comprising the dried sludge component and the gaseous component to a solid-gas separator, thereby separating the dried sludge component from the gaseous component. The method further comprises feeding a feed gas, which may be ambient air or preheated air and at least a portion of the dried sludge component to a hot air generator. In the hot air generator, the dried sludge component is combusted to generate heat of combustion. The heat of combustion thus generated is used to heat the feed gas and produce the drying gas for supply to the dryer.

In an embodiment, the method may use a start-up fuel, which may be fed to the hot air generator during the start-up phase of the system. The start-up fuel may be combusted in the hot air generator to generate heat of combustion, which may be used to heat the feed gas and produce the drying gas during the start-up phase. With the progress of the start-up phase, i.e. once the system starts producing the dried sludge component, the supply of start-up fuel is decreased, preferably gradually. Thus, the method and the system are self-sustaining.

In an embodiment of the invention, it dried sludge component thus produced may have 8 to 10% moisture content. Despite the presence of 8 to 10% moisture content, the dried sludge component may be directly combusted in the hot air generator. In an embodiment of the invention, the dried sludge component thus obtained has high calorific value, calorific value preferably in excess of 3500 kcal/kg. Because the dried sludge component has high calorific value, they can be easily used as fuel in many other applications. Thus, in case the amount of dried sludge component being produced is greater than what is needed for maintaining a self-sustaining operation of the system, the excess amount of the dried sludge component may be utilized for other applications.

In an embodiment of the invention, the ash as produced by combustion of the dried sludge component in the hot air generator is also of substantially good quality. By way of non-limiting example, the quality of ash thus produced is such that it can be used along with other materials for surfacing of metal roads.

In an embodiment of the invention, the temperature of the drying gas thus generated is in the range of 300 to 400° C. Preferably, the temperature of the drying gas thus generated is in the range of 325 to 375° C. In an embodiment of the invention, the drying gas is fed to the dryer at a pressure/flow rate sufficient to maintain the dried sludge component in a fluidized state in the dryer.

In an embodiment of the invention, because the heat carried by the drying gas is utilized for the purposes of drying the sewage sludge, the temperature of the gaseous component is not substantially high. In any event, it is envisaged that prior to disposal of the gaseous component, the temperature of the same may be reduced. For the purposes of reducing the temperature of the gaseous component, it is possible to mix the gaseous component thus produced with atmospheric air so as to reduce its temperature.

While the invention has been described with respect to a specific method which includes presently preferred modes of carrying out the invention, those skilled in the art will appreciate that there are numerous variations and permutations of the above-described embodiment that fall within the spirit and scope of the invention. It should be understood that the invention is not limited in its application to the details of construction and arrangements of the components set forth herein. Variations and modifications of the foregoing are within the scope of the present invention. Accordingly, many variations of these embodiments are envisaged within the scope of the present invention.

The foregoing descriptions of the specific embodiment of the present invention have been presented for purposes of description. They are not intended to be exhaustive or to limit the present invention to the precise forms disclosed, and obviously many modifications and variations are possible in light of the above teaching. The embodiment was chosen and described in order to best explain the principles of the present invention and its practical application, and to thereby enable others skilled in the art to best utilize the present invention and various embodiment with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

1. A system (100) for reducing a volume of sewage sludge, comprising:
a dryer (102) adapted to receive the sewage sludge and a drying gas and produce a mixture comprising a dried sludge component and a gaseous component therefrom;
a solid-gas separator (104) for separating the dried sludge component from the gaseous component; and
a hot air generator (106) connected to said solid-gas separator (104) and the dryer (102), the hot air generator (106) adapted to receive a feed gas and at least a portion of said dried sludge component from the solid-gas separator (104), the hot air generator being further adapted to combust the dried sludge component to produce a heat of combustion and convert, using the heat of combustion, the feed gas to drying gas for supply to the dryer (102).

2. The system as claimed in claim 1, further comprising:
a storage means (202) for receiving said sewage sludge;
a conveyor means (204) for transporting the sewage sludge from the storage means (202) to the dryer (102).

3. The system as claimed in claim 1, wherein the dryer is a direct heating type dryer comprising a drying gas inlet port (206) located at about a bottom of the dryer, whereby said drying gas is supplied to the direct heating type dryer and allowed to flow upward and to mix with sewage sludge thereby producing the dried sludge component and the gaseous component.

4. The system as claimed in claim 3, wherein the direct heating type dryer is provided with a size reduction means (208) for reducing a size of the sewage sludge.

5. The system as claimed in claim 1, wherein the solid-gas separator (104) is selected from a group comprising a cyclone separator (210), a bag separator (212), a scrubber (214), an electrostatic precipitator (216), and combinations thereof.

6. The system as claimed in claim 1, wherein the hot air generator (106) comprises:
a feed gas inlet port (218) for introducing the feed gas;
a first fuel inlet port (220) for introducing the dried sludge component received from the solid-gas separator (104); and
a combustion zone (222) in operational interconnectivity with the feed gas inlet port (218) and the first fuel inlet port (220) for receiving there-from the feed gas and the dried sludge component, respectively, the combustion zone (222) being adapted to combust the dried sludge component to produce a heat of combustion and convert, using the heat of combustion, the feed gas to drying gas for supply to the dryer (102).

7. The system as claimed in claim 6, wherein the hot air generator (106) comprises at least one ash-separation zone (224) located downstream of the combustion zone (222) for promoting separation of ash from the drying gas, the ash being produced by combustion of the dried sludge component in the combustion zone (222).

8. The system as claimed in claim 6, wherein the hot air generator (106) comprises a second fuel inlet port (226) for introducing a start-up fuel to the combustion zone.

9. A method for reducing a volume of sewage sludge, comprising:
feeding the sewage sludge and drying gas to a dryer thereby producing a mixture comprising a dried sludge component and a gaseous component;
feeding the mixture comprising the dried sludge component and the gaseous component to a solid-gas separator thereby separating the dried sludge component from the gaseous component;
feeding a feed gas, at least a portion of said dried sludge component and optionally a start-up fuel to a hot air generator;
combusting the dried sludge component and optionally the start-up fuel in the hot air generator to produce a heat of combustion; and
converting, the feed gas to drying gas for supply to the dryer (102), using the heat of combustion.

10. The method as claimed in claim 9, wherein feeding the drying gas to the dryer comprises feeding the drying gas at a pressure/flow rate sufficient to maintain the dried sludge component in a fluidized state within the dryer.
